(19) United States
(12) Patent Application Publication
(10) Pub. No.: US 2009/0271481 A1
(43) Pub. Date: Oct. 29, 2009

(54) Online Idea Collaboration

(76) Inventor: Adrienne Becker, Beverly Hills, CA (US)

Correspondence Address: MERCHANT & GOULD PC, P.O. BOX 2903, MINNEAPOLIS, MN, 55402-0903, US

(21) Appl. No.: 12/429,715

(22) Filed: Apr. 24, 2009

Related U.S. Application Data
(60) Provisional application No. 61/047,803, filed on Apr. 25, 2008.

(51) Int. Cl. G06F 15/16

(52) U.S. Cl. 709/204

(57) ABSTRACT

A computing device for online idea collaboration includes a processor, and a computer readable storage medium. The processor creates a publishing module programmed to allow authors to publish ideas, the publishing module including an interface that requests various information regarding each of the ideas. The processor creates a ratings module programmed to allow reviewers to rate each of the ideas, the ratings module presenting questions to the reviewers to allow the reviewers to rate each of the ideas. The processor creates a valuation module programmed to calculate a ratings value for each of the ideas, the ratings value being based, at least in part, on data from the ratings module, and the ratings value providing an estimate of each idea's chances for success.

### RELATED APPLICATIONS

This application claims the benefit of U.S. Patent Application Ser. No. 61/047,803 filed on Apr. 25, 2008, the entirety of which is hereby incorporated by reference.

### BACKGROUND

Most people have ideas on how to improve elements of their lives. However, people often fail to capitalize on good ideas because they do not have the knowledge or resources to bring their ideas to fruition. For example, people may not know how to gamer the necessary feedback to develop their ideas into marketable products. Also, people may not have the connections that are typically necessary to finance the potentially high costs of development, manufacture, marketing, and distribution of products embodying their ideas.

### SUMMARY

In one aspect, a computing device for online idea collaboration includes a processor, and a computer readable storage medium. The processor creates a publishing module programmed to allow authors to publish ideas, the publishing module including an interface that requests various information regarding each of the ideas. The processor creates a ratings module programmed to allow reviewers to rate each of the ideas, the ratings module presenting questions to the reviewers to allow the reviewers to rate each of the ideas. The processor creates a valuation module programmed to calculate a ratings value for each of the ideas, the ratings value being based, at least in part, on data from the ratings module, and the ratings value providing an estimate of each idea's chances for success.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example online idea collaboration system.

FIG. 2 shows example modules of the online idea collaboration system of FIG. 1.

FIG. 3 shows example modules of the idea publishing module of FIG. 2.

FIG. 4 shows example actors in the online idea collaboration system of FIG. 1.

FIG. 5 shows an example graphical user interface of the online idea collaboration system of FIG. 1.

FIG. 6 shows an example idea module of the interface of FIG. 5.

FIG. 7 shows an enlarged view of a portion of the idea module of FIG. 6.

FIG. 8 shows an example voting module of the interface of FIG. 5.

FIG. 9 shows an example multimedia module of the interface of FIG. 5.

FIG. 10 shows an example search module of the interface of FIG. 5.

FIG. 11 shows an example method for online idea collaboration.

FIG. 12 shows an example method for generating an idea module.

FIG. 13 shows an example method for estimating a ratings value for an idea.

FIG. 14 shows an example method for sponsors to sponsor an idea.

### DETAILED DESCRIPTION

This application is directed to systems and methods for saving, sharing, developing, valuing, and attracting sponsors for ideas.

In example embodiments, authors publish ideas on an online system that can be viewed by other users. A user who is interested in an idea can review the idea and rate it. The system tracks the ratings and demographics associated with the users. As ratings are accumulated for an idea, the system estimates a value for the idea that correlates with the idea's chances of success. This value is made available to potential sponsors of the idea who may be interested in providing resources to help develop the idea.

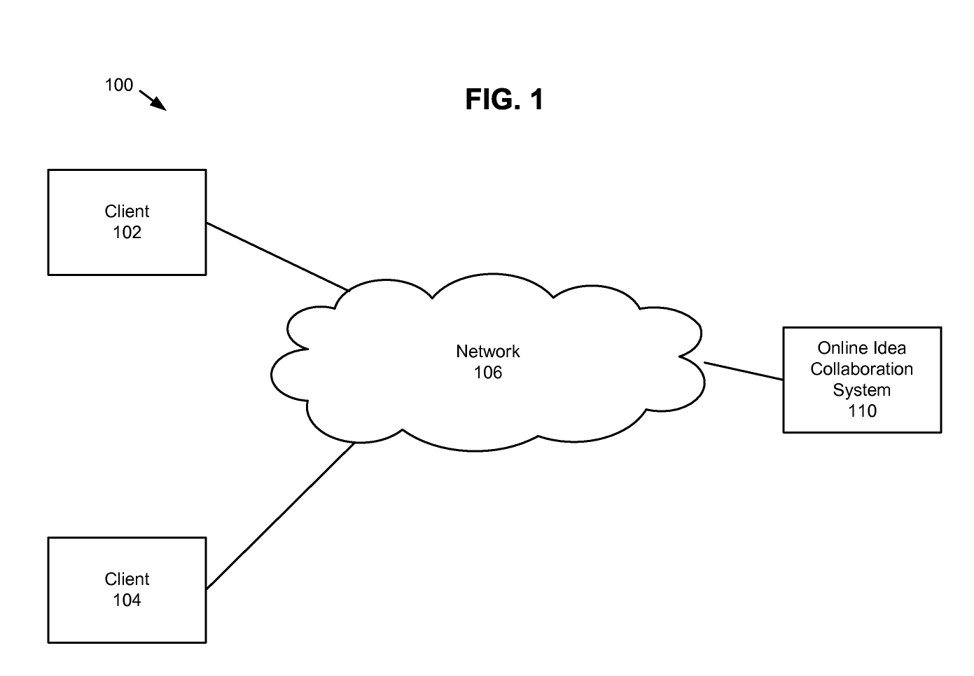

Referring now to FIG. 1, an example system 100 is shown that supports online idea collaboration. The example system 100 includes clients 102, 104, a network 106, and an online idea collaboration system 110.

In example embodiments, the clients 102, 104 and the system 110 are each computing devices, such as a desktop computer, laptop computer, personal data assistant, or cellular device. The clients can include input/output devices, a central processing unit (“CPU”) or processor, a data storage device, and a network device. Typical input/output devices include keyboards, mice, displays, microphones, speakers, disk drives, CD-ROM drives, and flash drives.

Computer readable media, such as a data storage device, provides for data retention. Computer readable media can include computer readable storage media and communication media. Computer readable storage media includes volatile and nonvolatile, removable and non-removable media implemented in any method or technology for storage of information such as computer readable instructions, data structures, program modules or other data. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal.

Among the plurality of information stored on the data storage device is a client operating system (“OS”) and client applications. The client OS is a program that manages the hardware and software resources of the computing device. The client applications utilize the resources of the clients 102, 104 and the system 110 to directly perform tasks specified by the user.

The network 106 is a local area network or the Internet. The network 106 enables the clients 102, 104 to send and receive data to/from the system 110. In the example shown, the system 110 includes a web server that is accessible through the network 106. The system 110 hosts a plurality of files and applications. Individuals can use applications running on the clients 102, 104, such as an Internet web browser, to access the system 110. Other configurations for the clients 102, 104, the network 106, and the system 110 are possible.

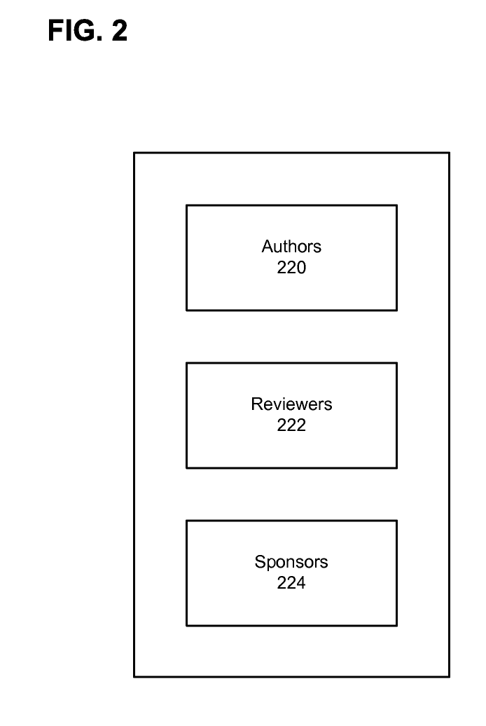

Referring now to FIG. 2, there are several groups of individuals that access and use the online idea collaboration system 110, including authors 220, reviewers 222, and sponsors 224.

The authors 220 are individuals who register with the system 110 and desire to publish their ideas on the system 110. For example, as described further below, each of the authors 220 provides the system 110 with various details about the author's idea(s).

The reviewers 222 are individuals that access the system 110 to review the ideas posted by the authors 220. In some examples, the reviewers 222 are required to register with the system 110 before the system 110 allows the reviewers 222 to access the ideas. As described further below, the reviewers 222 can browse and search for posted ideas, review details about the ideas, and rate the ideas. In some examples, an individual can be one of the authors 220 when the individual posts an idea, and can be one of the reviewers 222 when the individual reviews and rates other author's ideas.

The sponsors 224 are individuals, organizations such as corporations, investment firms such as venture capital firms, or other similar organizations that are willing to provide information (e.g., know-how), resources (e.g., prototyping or manufacturing capabilities), marketing capabilities, and/or financing (e.g., venture capital, etc.) to sponsor ideas that are posted on the system 110. In some examples, the sponsors provide resources to the authors in exchange for an interest in the idea, such as an ownership interest, a license to make and/or distribute the product or service embodying the idea, first right of refusal to purchase the idea, etc.

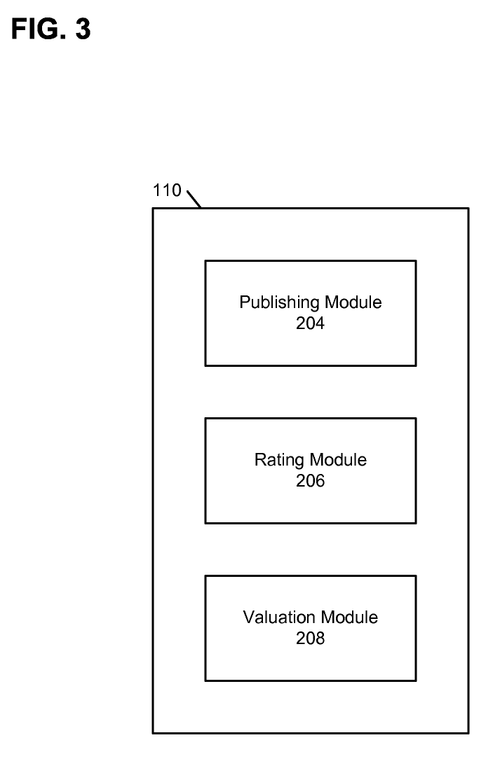

FIG. 3 shows details of the online idea collaboration system 110. In the example shown, the system 110 includes a publishing module 204, a ratings module 206, and a valuation module 208.

The example publishing module 204 is programmed to allow authors 220 to publish ideas on the system 110. The publishing module 204 presents the author with an interface that requests various information regarding the idea. For example, in one embodiment, the publishing module 204 is programmed to ask the author describe the idea, provide a name for it, and categorize it. In addition, the author is asked to estimate how much money it will take to finance the idea over an initial period, typically 1 month, 6 months, 12 months, 18 months, or 24 months.

The author is also asked to indicate the type of assistance he or she will need to develop the idea. For example, if the idea requires manufacturing facilities to produce a product, the author can indicate that help with developing a relationship with a manufacturer is needed. In addition, the author can select a desired sponsor to fund development of the idea, such as by selecting among a list of potential sponsors that have registered with the system 110. The author is also asked to provide the name of a non-profit beneficiary for the idea, as described further below.

The author can further provide one or more questions that are posed to the reviewers 222. Example questions include: (i) Would you be a customer for this product or service; (ii) Would you purchase this product or service; and (iii) Would you support further development this idea? In some embodiments, the author can create his or her own questions. In other examples, there is a list of pre-created questions from which the author can select. The questions can be tailored to specific issues associated with the idea. For example, if the idea requires sophisticated manufacturing to produce a product, one of the questions might be “Do you support development of the facilities necessary to manufacture a product embodying the idea?” In yet other examples, the questions can be pre-selected and generically applied to every idea.

Other types of information can also be gathered from authors. For example, in the embodiment shown, the author can also post news associated with develop of the author's idea, as well as post pictures, videos, and documents related to the idea.

The example ratings module 206 of the system 110 is programmed to allow the reviewers 222 to rate an idea. For example, when one of the reviewers 222 is interested in an idea, the reviewer can review the material related to the idea submitted to the system 110 by the author. The reviewer can then rate the idea by answering questions related to the idea. In one example, the reviewer rates the idea by selecting a numerical value associated with each question, typically a number from a scale of 1-5 or 1-10. The higher the number, the more positive the response. In other examples, the rating schemes can be different, such as requiring a simple “Yes” or “No” answer to each question.

In example embodiments, the ratings module 206 is programmed to require that the reviewers 222 register with the system 110 before the reviewers 222 can review and/or rate the ideas. First time reviewers 222 are asked to register by providing demographic data such as their year of birth, gender, zip code and email address. Other information, such as household income, purchasing habits, and the like, can also be collected.

This demographic data can be used to further analyze the ratings made by the reviewers 222. The demographic data can also used to provide analysis of the potential market for the idea to prospective sponsors 224. For example, as described further below, the ratings value for an idea can be used by prospective sponsors 224 to determine whether or not to sponsor a particular idea. Ideas with a high ratings value may indicate an increased likelihood that a prospective sponsor will fund the idea.

The example valuation module 208 of the system 110 is programmed to calculate a ratings value for the idea. The ratings value is configured to provide an estimate of the idea's chances for success. In example embodiments, the valuation module 208 processes various information associated with each idea to arrive at the ratings value.

For example, in one embodiment, the valuation module 208 uses one or more of the following information to calculate the ratings value: ratings from the users that answer the posed questions; number of ratings for the particular idea and/or all ideas; number of visits for the idea and/or all ideas; and the category or categories associated with the idea. In one embodiment, the valuation module 208 uses the following example Equation A to calculate the ratings value for an idea:

$$W \times ( \frac{cum . {votes}_{i}}{ave . cum . votes} ) \times ( ave \cdot SQ {1}_{i} + ave \cdot SQ {2}_{i} ) + X \times ( \frac{weekly . {visits}_{i}}{ave . week . visits} ) + Y \times ( \frac{weekly . cat . {hits}_{i}}{ave . cat . hits} ) + Z \times ( \frac{weekly . {votes}_{i}}{ave . weekly . votes} ) \qquad Eq . A$$

In Equation A, the indice i represents the current idea for which the ratings value is being calculated. The example variables and constants of Equation A are as follows:
cum.votes—cumulative ratings for the idea (i.e., ratings provided by users that answer the questions) for the idea;
ave.cum.votes—average of the cumulative ratings for all ideas;
ave.SQ1, ave.SQ2—average rating for each question for the idea;
weekly.visits—number of visits in a week for the idea;
ave.week.visits—average number of weekly visits for all ideas;
weekly.cat.hits—number of weekly visits to ideas associated with the same category as that of the idea;
ave.cat.hits—average number of visits to ideas associated with the same category as that of the idea;
weekly.votes—number of ratings in a week for the idea;
ave.weekly.vots—average number of ratings in a week for all ideas; and
W, X, Y, Z—constants used to manipulate the weight associated with the variables in Equation A (e.g., W=4, X=3, Y=1, and Z=2).

Other variables and constants can be used. For example, other information, such as demographic data associated with the reviewers 222 that provide ratings on the idea, can also be used to calculate the ratings value. In other examples, different time periods, such as a month, can be used to calculate the cumulative values (e.g., the average ratings per month for a particular idea).

In the embodiment shown, the example valuation module 208 provides a histogram of each idea's ratings value. The ratings value for the idea is calculated on an ongoing basis. In some embodiments, the ratings value is not presented to the reviewers 222 until after the reviewers 222 have rated a particular idea. This is done to preserve each reviewer's independence. The reviewer is able to change his or her rating, so that the ratings value for the idea provides a current reflection of how the reviewing community values the idea.

In other examples, the ratings value is made visible to the reviewers 222 so that the reviewers 222 can see the current ratings value before rating the idea themselves. In yet other embodiments, the reviewer can request to, but need not, see the current ratings value before rating the idea. In addition, the impact that each of the ratings has on the ratings value can be modified based on certain parameters. For example, the reviewer's ratings for an idea can be discounted a certain amount if the review requests to see the current ratings value before providing the reviewer's ratings. Other configurations are possible.

In alternative embodiments, multiple ratings values can be provided for each idea. For example, ratings values can be provided for different aspects related to development of the idea, such as marketing potential, easy of development/manufacture, profit potential, product liability risk, etc. In such an embodiment, separate ratings values can be provided for each aspect, and an overall ratings value can be calculated as an average of the other ratings values.

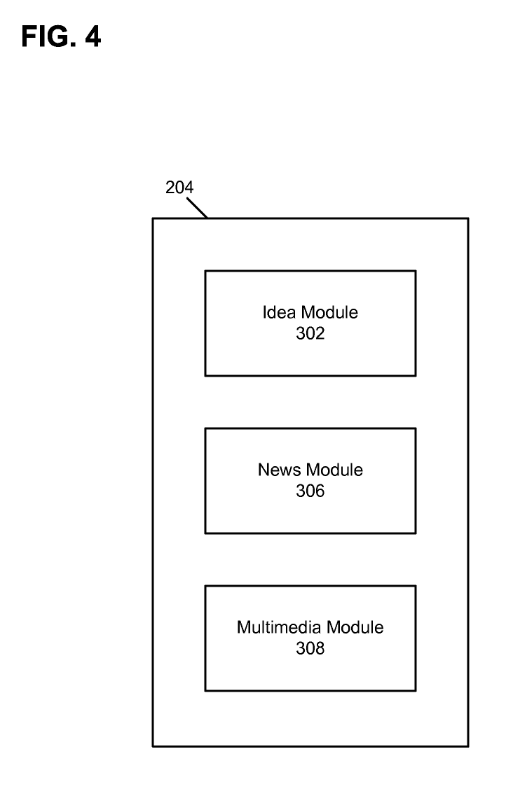

Referring now to FIG. 4, the example publishing module 204 is shown in more detail. The publishing module 204 includes an idea module 302, a page module 304, a news module 306, and a multimedia module 308.

The example idea module 302 stores information about each idea entered by the authors 220. As noted above, this information can include: name; detailed description of idea; brief description of idea for the public; idea category; level of financial need; potential sponsors; relevant questions to ask reviewers and potential sponsors; type of help that might be needed to develop the idea; and non-profit beneficiary for the idea. Other information may also be stored.

The example news module 306 is programmed to permit authors 220 to publish stories about new developments related to their ideas. For example, the news module 306 allows the authors 220 to post updates on the development of their ideas, as well as success stories related to marketing of the ideas.

The example multimedia module 308 is programmed to allow authors 220 to post pictures, videos, and documents related to their ideas. For example, an author can post pictures and videos of the idea in use, as well as marketing literature associated with products or services embodying the idea.

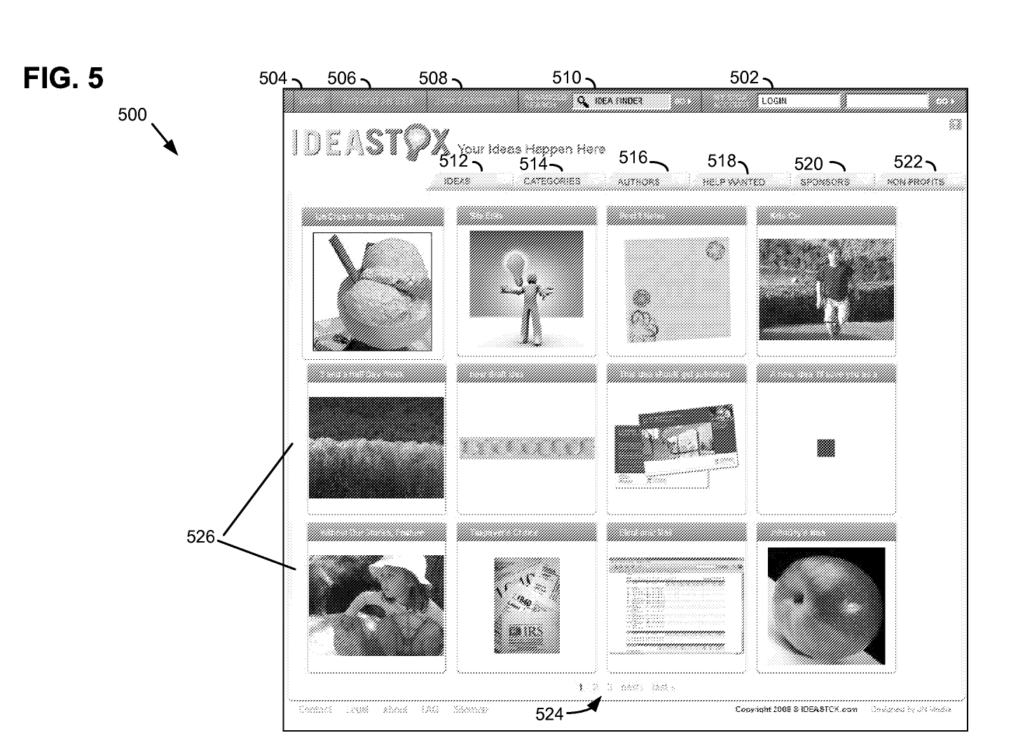

FIG. 5 shows an example graphical user interface 500 that is presented to users when logging into the system 110. In example embodiments, the interface 500 is a web page written in hypertext markup language (HTML) that is delivered to users' computers over the hypertext transport protocol (HTTP) or a similar technology.

Generally, the interface 500 provides reviewers 222 with high level information about a plurality of ideas that are stored on the system 110. Across the top of the example interface 500 are modules 502, 504, 506, 508, 510 that provide access to various functions on the system 110.

The module 502 allows the user to enter the user's login name and password to access the system 110. For example, the authors 220 can log into the system 110 to add an idea or update an existing idea. Similarly, the reviewers 222 can log into the system 110 to review and/or rate the posted ideas, and the sponsors 224 can access the system to review and sponsor ideas.

The module 504, when selected, is programmed to bring the user back to a home page for the user. In example embodiments, the home page can be a generic page that is shown to all users when the users log into the system, or can be a customized page that provides relevant information to the particular user. For example, the home page for an author can provide specific information (e.g., ratings value) for each idea that has been posted by the author.

When selected, the module 506 is programmed to load a user interface for an author to enter information about a new idea into the system 110. As described below, this can include such information as title, description, desired sponsor, selected non-profit organization, etc.

The module 508 is programmed to display community information when selected. For example, in one embodiment, users of the system 110 can be organized into groups or communities based on common interests. For example, communities can be pre-selected or created by users for various causes, such as the environment, healthcare etc. In addition, other online collaborative tools, such as forums, email, instant messaging, blogging, and the like can be provided to further enhance communication.

In addition, the module 508 can be programmed to provide other assistance and resources to the authors 220, such as FAQs on how to use the system 110 or how to develop, market, and sell a product. The module 508 can provide other information as well, such as resources to help the authors 220 protect any intellectual property associated with their ideas. Other information can also be provided.

The module 510 is programmed to allow users to search for a particular idea. The module 510 includes a search engine that allows users to search for ideas by entering one or more search terms. Simple searches can be done by entering search terms in the module 510. Advanced searches can be done by selecting the “Advanced Search” portion of the module 510 to load an advanced search interface 507.

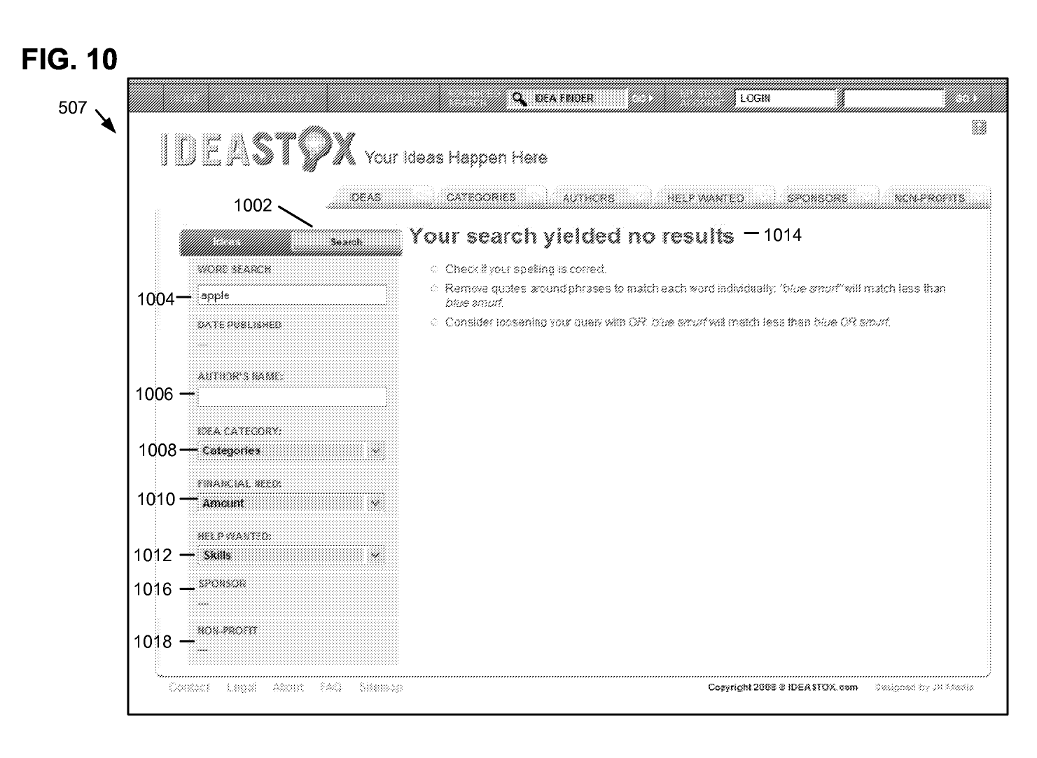

For example, as shown in FIG. 10, advanced searches can be done by entering one or more search terms into the various fields of the advanced search interface 507. This includes entering keywords into a word search box 1004. A search can be done on the author's name by entering a name in a text box 1006. A search can be done by idea category by selecting a category from example drop down list box 1008. A search can be done on financial need by selecting a dollar range from example drop down list box 1010. A search can be done on help-wanted skills by selecting a skill from example drop down list box 1012. Once search terms from one or more boxes 1004, 1006, 1008, 1010, 1012 are provided, the user clicks on a search button 1002 to initiate the search. The results of the search are displayed on an interface 1014. In some examples, additional search boxes, such as a drop down box 1016 to select a sponsor name or a drop down box 1018 to select a non-profit name, can also be provided.

Referring again to FIG. 5, the example interface 500 also includes tabs 512, 514, 516, 518, 520, 522 that allow the user to access various areas of the system 110 when selected.

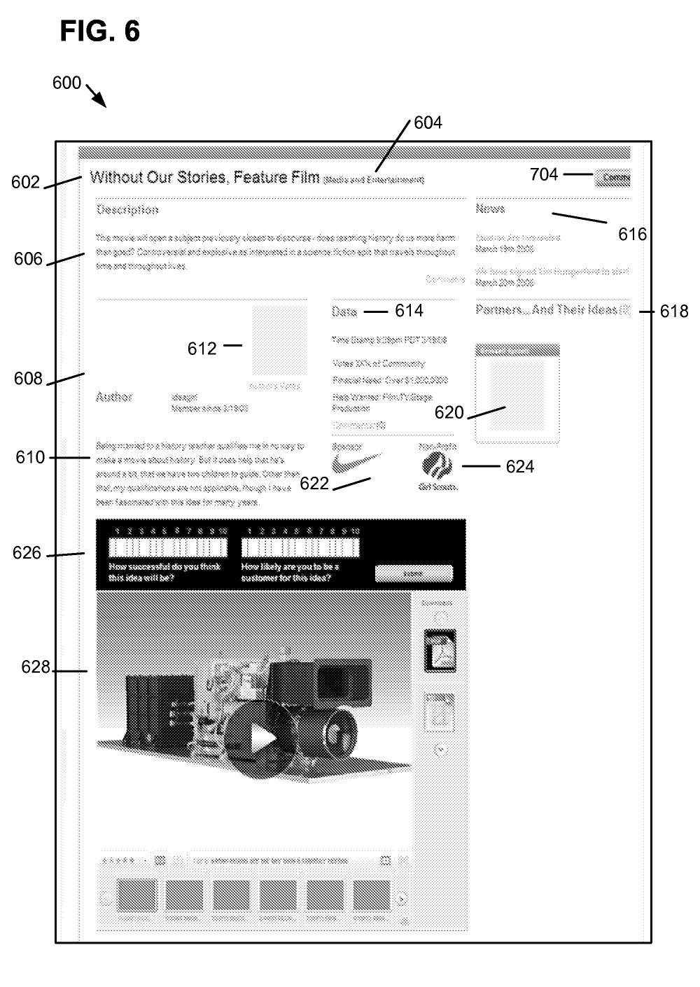

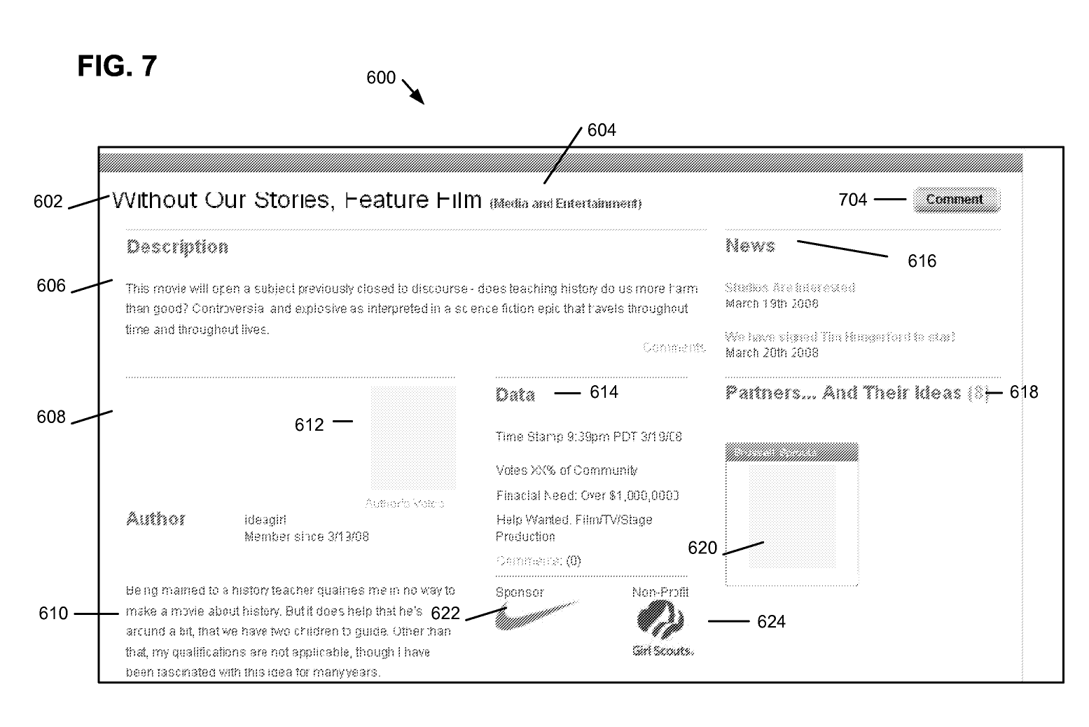

Tab 512 is programmed to bring up a summary listing of the ideas that have been posted on the system 110. For example, the interface 500 includes a plurality of panes 526 that provide summary bibliographic information related to the ideas that are available on the system 110. In the example shown, each pane 526 includes the name of the idea and a picture associated with the idea. The user can select one of the panes 526 to load a page with detailed information about the idea. See FIGS. 6-9 described below. If all of the panes 526 do not fit on one page, the user can select links 524 to display the next page(s) of ideas.

The tab 514 is programmed to display idea categories. Each of the ideas that is listed on the system 110 can be associated with one or more of the categories based on the content of the idea. Examples of such categories include advertising, advocacy, animals, education, electronics, environment, financial services, legal, sports, etc. The idea categories are displayed in a drop down menu when the tab 514 is selected, although other configurations are possible. When the user selects a category, the interface 500 is modified to include one or more panes 526 for ideas that are associated with the selected category.

The tab 516 is programmed to display the names of the authors 220 who have entered ideas into the system 110. The names can be listed in various orders, such as alphabetically, based on the number of ideas that have been posted, or based on the ratings value associated with the idea(s) posted by the author. Again, the list can be presented in various manners, such as a drop down list that is shown when the tab 516 is selected. When the user selects an author, the interface 500 is modified to include one or more panes 526 for ideas that are associated with the selected author.

The tab 518 is programmed to display a list of job categories for which an author has requested help. Example job categories may include financial management, engineering, cooking, etc. The job list can be presented in various manners, such as a drop down list in alphabetical order that is shown when the tab 518 is selected. When the user selects a job, the interface 500 is modified to include one or more panes 526 for ideas that are associated with the selected job.

The tab 520 is programmed to display a list of sponsors that have registered with the system 110. When the user selects a sponsor, a page is delivered that provides additional details related to the sponsor, such as a description about the sponsor and the sponsor's web site. In addition, the users can access one or more panes 526 for ideas that are associated with the selected sponsor. For example, in one embodiment, authors and reviewers can search for all of the ideas that have been sponsored by a particular sponsor. In another example, the sponsors 224 can search for all ideas that have requested that a certain sponsor provide support for the ideas.

The tab 522 is programmed to display a list of non-profit organizations to which authors 220 may contribute. For example, in one embodiment, the authors 220 are required to contribute a certain percentage of funding (e.g., money provided by sponsors 224) or profits (e.g., from the sale of goods or services embodying the idea) to a non-profit organization of each author's choice. In some embodiments, the non-profits can register with the system 110. The non-profits can be oriented to a certain cause (e.g., environment, healthcare, etc.), and the author can select the non-profit based on a match with the author's idea or simply select a non-profit with a mission in which the author believes.

Referring now to FIGS. 6-9, when a user selects (e.g., by clicking on) one of the panes 526, an example idea interface 600 is shown. Generally, the interface 600 provides the user with information related to the selected idea.

In example embodiments, the example interface 600 includes a title 602 and lists a category 604 for the idea. In this example, the title 602 is “Without Our Stories, Feature Film,” and the category 604 is “Media and Entertainment.” A module 606 provides a short description or abstract of the idea. A module 608 includes space for one or more pictures (none shown) related to the idea provided by the idea's author. A module 610 provides additional details about the author, such a bibliographic details about the author's life.

A module 612 provides a summary of the ratings that have been created for the idea. For example, in some embodiments, the module 612 includes a graph (e.g., bar graph, histogram etc.) representing the ratings for the idea over a particular period of time (e.g., for the past month, for the past year, or since inception of the idea on the system). In addition, a data module 614 provides bibliographic information related to the idea. In one embodiment, the data module 614 includes information such as the date the idea was submitted to the system 110, current rating totals for the idea, financing needed for the idea, and categories of help needed for the idea. Other information can also be provided.

Additional information included on the interface 600 includes a news module 616 including information about the idea. For example, the author can post updates regarding the idea to the news module 616, such as success stories in the development and implementation of the idea. A link 618 provides the user with an interface listing other ideas associated with the currently-displayed idea. For example, in one embodiment, the link 618 provides access to any other ideas that the author has posted on the system. In other examples, the link 618 can provide access to other ideas associated with the current idea, such as ideas from other authors associated with the current author or other ideas in the same subject-matter area. Other configurations are possible.

The interface 600 also includes an advertising module 620 that is programmed to display advertising to the user. In example embodiments, the advertising module 620 is programmed to analyze the idea and to display advertising that may be relevant to the user based on the idea displayed on the interface 600. For example, if the idea relates to a new cooking spray, the advertising module 620 is configured to select advertisements relating to cooking to display to the user. Other configurations are possible.

The interface 600 also includes a sponsors module 622 that lists the one or more sponsors that have agreed to provide assistance (e.g., know-how or funding) for the idea displayed. Also, a module 624 lists the non-profit organization(s) to which the author intends to contribute.

In addition, a comments button 704 allows the user to provide feedback related to the current idea or the use of the system 110. For example, in some embodiments, the user selects the comments button 704 to access forums that are idea-specific. The user can leave feedback regarding the idea. In yet other embodiments, the user selects the comments button 704 to provide feedback directly to the author. In yet other examples, the user selects the comments button 704 to flag the idea if, for example, the idea has inappropriate content. Other configurations are possible.

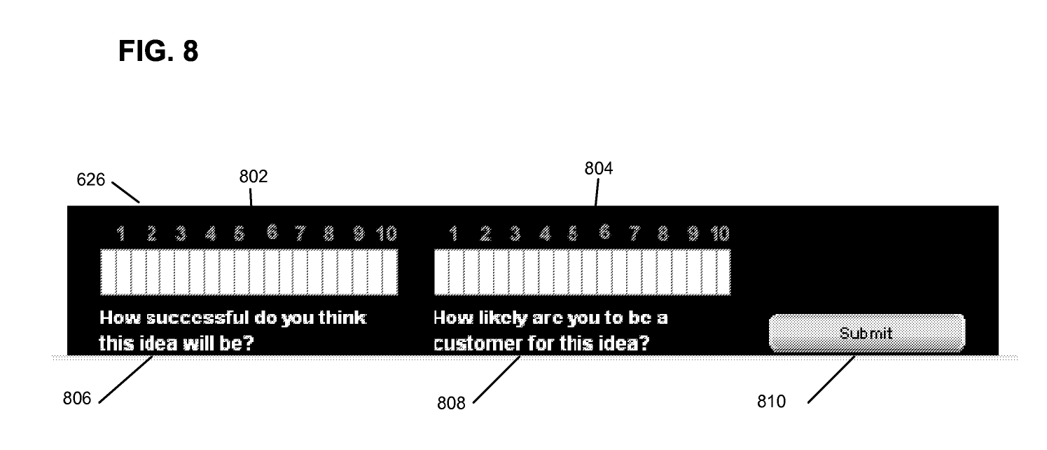

Referring now to FIGS. 6 and 8, the example interface 600 also includes a ratings module 624 that allows the reviewers 222 to rate the authors' 220 ideas. The ratings module 624 is programmed to query the reviewers 222 with one or more questions about the idea and ask the reviewers 222 to rate their answers on a scale of 1 to 10. A first example question 806 is: “How successful do you think this idea will be?” The reviewer can use a rating scale 802 to answer this question by selecting a number from 1 to 10. A second example question 808 is: “How likely are you to become a customer for this idea?” Visitors use a rating scale 804 to answer this question. The reviewer then clicks on a submit button 810 to submit the ratings values. As previously described, the answers to the questions can be used to calculate the ratings value for the idea. In other embodiments, more or fewer questions can be posed, and the answers can be gathered using various methods.

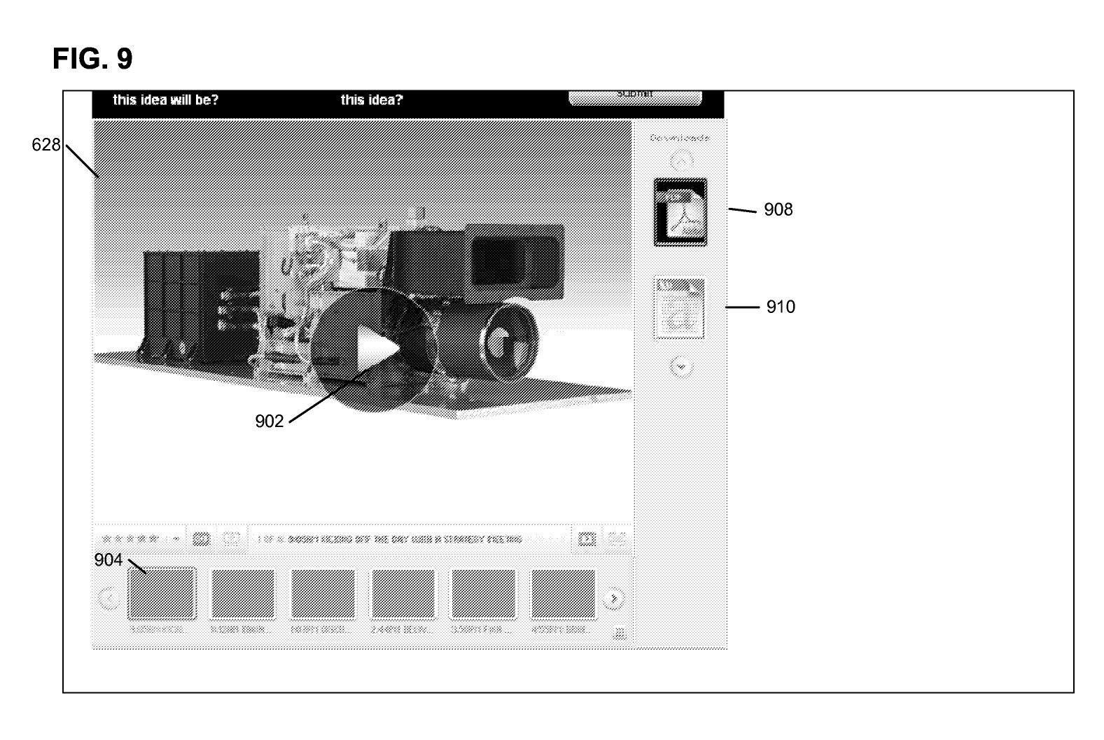

Referring now to FIGS. 6 and 9, the example interface 600 also includes a multimedia module 628 that is programmed to allow the author to post pictures, videos, and documents related to the idea. The example module 628 includes a video 902, pictures 904, a PDF document 908, and a Microsoft Word document 910 that are related to the idea. For example, the author can include videos and/or pictures illustrating the creation or use of the idea. The author can also include documents that further describe the idea and/or marketing documents related to the idea. When a user selects one of the videos 902, pictures 904, or documents 908, 910, the selected file is loaded and displayed in the module 629.

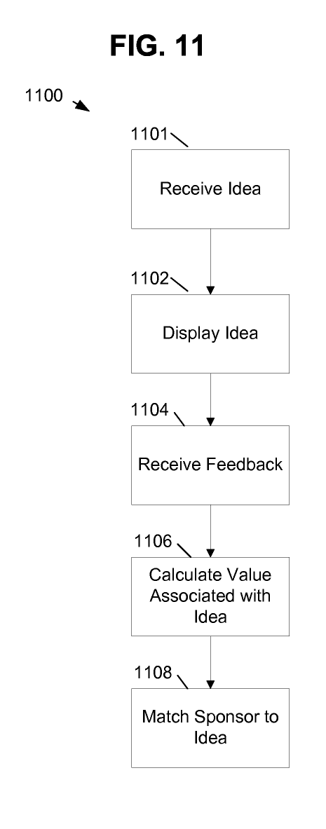

FIG. 11 shows an example method 1100 for online collaboration of ideas. Initially, at operation 1101, an author's idea is received by the system. Next, at operation 1102, the idea is displayed to users of the system. At operation 1104, reviewers provide feedback about the idea such as, for example, by rating the idea as described above. Next, at operation 1106, a ratings value is calculated for the idea based on the feedback and other information, such as demographic data. Finally, at operation 1108, sponsors are matched to the idea based on the content of the idea and the ratings value associated with it.

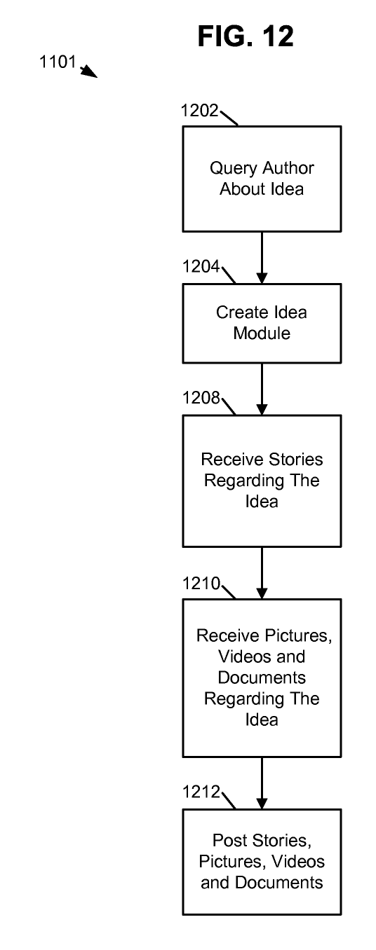

FIG. 12 shows additional details on the operation 1101 related to receiving the idea from the author. At operation 1202, the author is queried about his or her idea. For example, as described above, the author can be asked to provide information about the idea such as the name of the idea, a description of the idea, an image depicting the idea, an idea category, etc.

Next, at operation 1204, the idea information is used to create an idea module that can be displayed to other users of the system. For example, the interface 600 can be generated when users select the idea to gather more information about the idea and to rate the idea.

In addition, additional information about the idea can be collected from the author at the time the author posts the idea or at a later date. For example, at operation 1208, the system receives stories, and, at operation 1210, the system receives pictures, videos, and documents from the author related to the idea. Next, at operation 1212, the stories, pictures, videos and documentation are posted so that they can be viewed by users of the system.

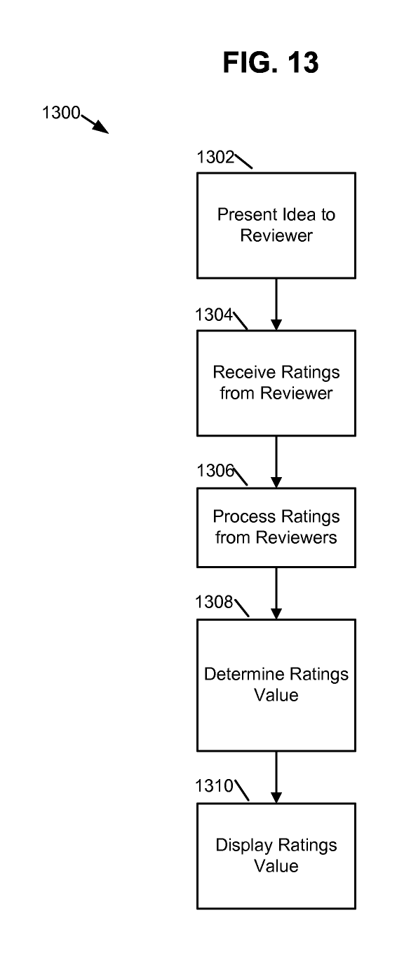

FIG. 13 shows an example method 1300 for determining a ratings value for an idea. At operation 1302, the idea is presented to a reviewer to review. Next, at operation 1304, one or more ratings are received from the reviewer. For example, as described above, the ratings can be provided in response one or more questions related to the idea that are displayed on the interface 500.

Next, at operation 1306, the ratings are processed. At operation 1308, the ratings data can be used in conjunction with other data, such as demographics data, to determine a ratings value that corresponds to the ideas chance of success. At operation 1310, the numerical ratings value for the idea is displayed on the system to the author, reviewers, and sponsors, so that they may see how the reviewers have valued the idea.

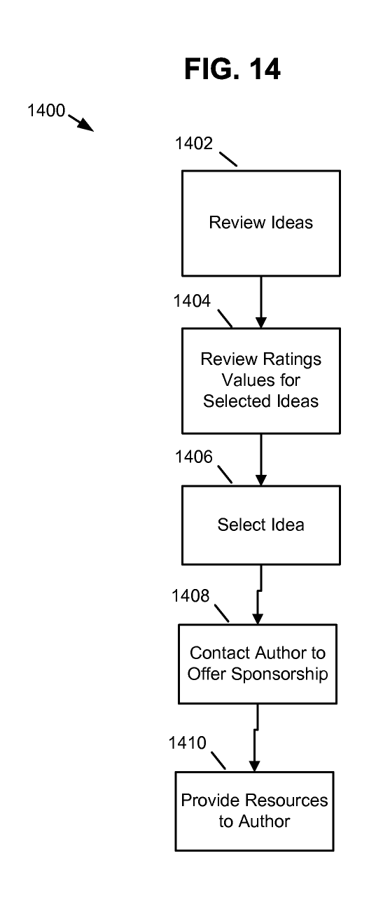

Referring now to FIG. 14, an example method 1400 is shown for sponsors to select and sponsor an idea. Initially, at operation 1402, the sponsors use the system to review different ideas. For example, the sponsors can search for ideas in a particular area using one or more of the search facilities described above. Also, in one example, when an author inputs an idea and selects a desired sponsor, the selected sponsor is notified of the selection and can review the idea.

Next, at operation 1404, the sponsor reviews the details related to the ideas, including the ratings values. Next, at operation 1406, the sponsor selects an idea for sponsorship.

At operation 1408, the sponsor contacts the author of the selected idea to offer to sponsor the idea. This contact can be in the form of an email or a telephone call to the author. Next, at operation 1410, the sponsor provides resources to the author if the author decides to accept the sponsorship. As described above, these resources can include such services as know-how, marketing assistance, financial assistance, etc.

The various embodiments described above are provided by way of illustration only and should not be construed to limiting. Various modifications and changes that may be made to the embodiments described above without departing from the true spirit and scope of the disclosure.

What is claimed is:

1. A computing device for online idea collaboration, the computing device comprising:
a processor; and
a computer readable storage medium encoding instructions that, when executed by the processor, cause the processor to create:
a publishing module programmed to allow authors to publish ideas, the publishing module including an interface that requests various information regarding each of the ideas;
a ratings module programmed to allow reviewers to rate each of the ideas, the ratings module presenting questions to the reviewers to allow the reviewers to rate each of the ideas; and
a valuation module programmed to calculate a ratings value for each of the ideas, the ratings value being based, at least in part, on data from the ratings module, and the ratings value providing an estimate of each idea's chances for success.
